(19) United States
(12) Patent Application Publication
(10) Pub. No.: US 2018/0328316 A1
(43) Pub. Date: Nov. 15, 2018

(54) TUBE, EGR COOLER HAVING TUBE, AND MANUFACTURING METHOD OF TUBE

(71) Applicants: HYUNDAI MOTOR COMPANY, Seoul (KR); KIA MOTORS CORPORATION, Seoul (KR)

(72) Inventors: Seok HA, Seoul (KR); Dong Young LEE, Goyang-si (KR); Sung Il YOON, Seoul (KR); Tae Ho JEONG, Yongin-si (KR)

(21) Appl. No.: 15/808,616

(22) Filed: Nov. 9, 2017

(30) Foreign Application Priority Data
May 11, 2017 (KR) 10-2017-0058623

(51) Int. Cl. F02M 26/29; C22F 1/04; C22C 21/00; B21C 23/08

(52) U.S. Cl. CPC F02M 26/29; B21C 23/085; C22C 21/00; C22F 1/04

(57) ABSTRACT

An exhaust gas recirculation (EGR) cooler having a tube, including a tube made of an aluminum alloy is installed to cool exhaust gas recirculated from an exhaust line of an internal combustion engine to an intake line of the EGR cooler. The aluminum alloy includes a predetermined weight ratio (wt %) of each of zirconium, silicon, iron, magnesium, and manganese.

### CROSS-REFERENCE TO RELATED APPLICATION

This application claims the benefit of priority to Korean Patent Application No. 10-2017-0058623, filed on May 11, 2017, with the Korean Intellectual Property Office, the entire contents of which are incorporated herein by reference.

### TECHNICAL FIELD

The present disclosure relates to a tube made of an aluminum alloy, and more particularly, to an exhaust gas recirculation (EGR) cooler having a tube that cools EGR gas that is discharged from an exhaust line of an internal combustion engine and is recirculated to an intake line thereof, and to a manufacturing method of the tube.

### BACKGROUND

Recently, regulations on exhaust gas have been strengthened due to environmental problems such as global warming, and particularly, stringent regulations on an amount of exhaust gas of a vehicle are being applied.

In particular, according to EURO-6, in case of a diesel engine for a passenger vehicle, a generated amount of NOx should be reduced to a level of 80 mg/km, and for this, automobile companies apply technologies such as EGR, LNT, SCR, etc.

Examples of EGR, include a high pressure exhaust gas recirculation (HP-EGR) device that recirculates exhaust gas and mixes the recirculated exhaust gas with compressed air, and a low pressure exhaust gas recirculation (LP-EGR) device that recirculates exhaust gas of a rear end of a diesel particle filter (DPF) and mixes the recirculated exhaust gas with air at a front end of a turbocharger.

In this case, in order to cool the recirculated exhaust gas, an exhaust gas recirculation line is provided with an EGR cooler, which is made of a stainless steel material which is highly corrosion resistant against high temperature condensate water.

The above information disclosed in this Background section is only for enhancement of understanding of the background of the presently disclosed subject matter and therefore it may contain information that does not form the prior art that is already known in this country to a person of ordinary skill in the art.

### SUMMARY

The present disclosure has been made in an effort to provide a tube that may maintain strength and may be highly resistant to corrosion in a condition in which corrosive ions such as Cr, SO₄²⁻, NO₃⁻, and the like as components of the condensate water are present and in which a temperature of recirculation exhaust gas reaches about 550 degrees Celsius, and in an effort to provide an EGR cooler having the tube, and a manufacturing method of the tube.

An embodiment of the present disclosure provides a tube used in a water-cooled EGR cooler, wherein the tube may be made of an aluminum alloy containing a predetermined weight ratio (wt %) of zirconium.

The aluminum alloy may contain a predetermined weight ratio (wt %) of copper, silicon, iron, magnesium, and manganese.

The aluminum alloy may include, when the respective element is present in the aluminum alloy, up to 0.01 wt % of copper, up to 0.2 wt % of silicon, up to 0.2 wt % of iron, 0.05 wt % to 0.1 wt % of magnesium, 0.8 wt % to 1.2 wt % of manganese, and 0.03 wt % to 0.06 wt % of zirconium.

Another embodiment of the present disclosure provides an EGR cooler having a tube, the tube being configured to be made of an aluminum alloy that includes a predetermined weight ratio (wt %) of zirconium, silicon, iron, magnesium, and manganese, wherein the tube is installed to cool exhaust gas recirculated from an exhaust line of an internal combustion engine to an intake line thereof.

The EGR cooler having the tube may further include a fin configured to be disposed in an exhaust gas passage inside the tube.

The fin may be made of an aluminum alloy, may have a shape of a zigzag-bent plate, and may be brazed to an inner surface of the tube.

The EGR cooler having the tube may further include more than one tube and a supporter configured to be interposed between successive tubes to form a coolant passage.

The supporter may be made of an aluminum alloy, may have a shape of a zigzag-bent plate, and may be bonded to an outer surface of the tube.

The EGR cooler having the tube may further include: a housing in which the more than one tubes are disposed at predetermined intervals; and an inlet and outlet pipe configured to serve for a coolant to flow in and be discharged from the housing.

Yet another embodiment of the present disclosure provides a manufacturing method of a tube, including: melting aluminum and an alloy material to form a molten metal; forming a billet of a predetermined shape with the molten metal; heat-treating the billet at a first temperature, maintaining the first temperature for a first time period, and then cooling the billet; and heat-treating the heat-treated billet at a second temperature, and then extruding it into the predetermined shape.

The alloy material may include copper, silicon, iron, magnesium, manganese, and zirconium.

The alloy material may include, when the respective element is present in the alloy material, up to 0.01 wt % of copper, up to 0.2 wt % of silicon, up to 0.2 wt % of iron, 0.05 wt % to 0.1 wt % of magnesium, 0.8 wt % to 1.2 wt % of manganese, and 0.03 wt % to 0.06 wt % of zirconium, with remainder being aluminum.

The first temperature may be 550 degrees Celsius.

The first time period may be 24 hours.

In the cooling, the billet may be air cooled.

The second temperature may be 520 degrees Celsius.

According to an embodiment of the present disclosure, it is possible to provide a tube made of an aluminum alloy that has high strength and improved corrosion resistance in a condition of which temperature is high and in which corrosive ions are present.

In addition, according to an embodiment of the present disclosure, it is possible to reduce a weight of an EGR cooler having a tube with an aluminum alloy material, to improve heat exchange efficiency, and to provide high strength and high corrosion resistance characteristics, thereby improving marketability and durability.

### BRIEF DESCRIPTION OF DRAWINGS

FIG. 1 illustrates a perspective view of an EGR cooler according to an embodiment of the present disclosure.

FIG. 2 illustrates a cross-sectional view of the EGR cooler taken along line II-II of FIG. 1.

FIG. 3 illustrates a component table of an aluminum alloy applied to a tube of an EGR cooler according to an embodiment of the present disclosure.

FIG. 4A and FIG. 4B illustrate cross-sectional views of an experimental aluminum alloy formed according to an embodiment of the present disclosure.

FIG. 5 illustrates a table representing a corrosion depth for an experimental aluminum alloy formed according to an embodiment of the present disclosure.

FIG. 6 illustrates a flowchart of a manufacturing method of an aluminum alloy according to an embodiment of the present disclosure.

### DETAILED DESCRIPTION

Hereinafter, an embodiment of the present disclosure will be described in detail with reference to the accompanying drawings.

However, the size and thickness of each component illustrated in the drawings are arbitrarily shown for ease of description and the thicknesses of portions and regions may be exaggerated for clarity. The present disclosure is not limited thereto.

In addition, parts that are irrelevant to the description are omitted to clearly describe embodiments of the present disclosure, and like reference numerals designate like elements throughout the specification.

In the following description, dividing names of components into first, second, and the like is to divide the names because the names of the components are the same, and an order thereof is not particularly limited.

An EGR cooler made of a typical stainless material is heavy, has low heat transfer efficiency, has poor moldability, and includes expensive parts. Thus, research on an EGR cooler made of an aluminum material, which has high heat transfer efficiency, good formability, and relatively low-cost parts, has been conducted.

A fin and a tube of a heat exchanger (which corresponds to a typical cooler) are made of A1100 which is a pure aluminum-based material (A1xxx) and A3003 which is an aluminum-manganese-based material (A3xxx), and a temperature of exhaust gas recirculated therein reaches about 550 degrees Celsius.

In addition, since corrosive ions such as Cl⁻, S0₄²⁻, NO₃⁻, and the like that are components of the condensate water are present in the tube, the aluminum-based fin or tube may be damaged in a high temperature and corrosive environment, and thus, research on high strength and high corrosion resistant aluminum plate has been conducted.

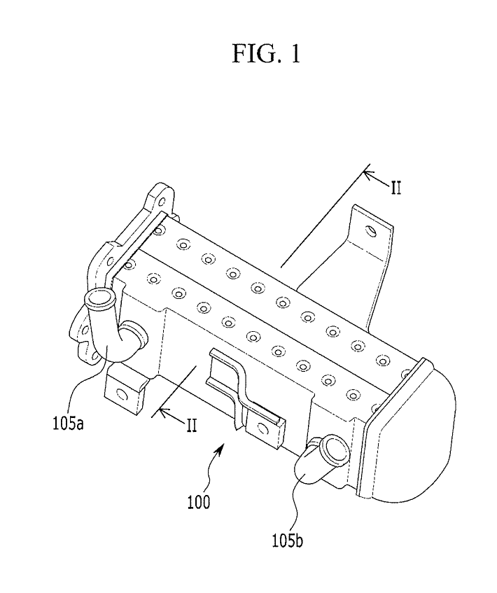

FIG. 1 illustrates a perspective view of an EGR cooler according to an embodiment of the present disclosure.

Referring to FIG. 1, an EGR cooler 100 is installed to cool exhaust gas recirculated from an exhaust line (not explicitly shown) to an intake line (not explicitly shown) in an engine system (not explicitly shown).

The EGR cooler 100 cools the recirculated exhaust gas by using a coolant, and is connected to a first coolant pipe 105a and a second coolant pipe 105b through which the coolant flows in and is discharged, respectively.

In an embodiment of the present disclosure, a temperature of the exhaust gas passing through the EGR cooler 100 reaches about 550 degrees Celsius, so when the exhaust gas temperature is lowered by the EGR cooler 100, condensate water is generate. The condensate water may include corrosive ions such as Cl⁻, SO₄²⁻, NO₃⁻, and the like dissolved in the condensate water.

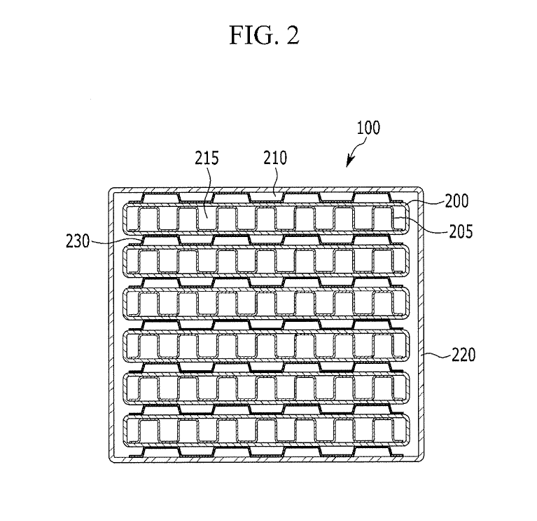

Accordingly, improving heat and corrosion resistant characteristics of an aluminum alloy used in a tube 200 (FIG. 2) and a fin 205 (FIG. 2) of the EGR cooler 100, such that it has higher strength and corrosion resistance than when a typical A3003 aluminum plate is used therein, in conditions where temperature is high and corrosive ions are present, is desirable.

In addition, using an aluminum plate formed of the aluminum alloy having heat and corrosion resistant characteristics, it is possible to reduce a weight of the EGR cooler 100 , improve heat exchange efficiency, and provide relatively high strength and high corrosion resistance, thereby improving marketability and durability. In the specification, unexplained portions refer to known techniques.

FIG. 2 illustrates a cross-sectional view of the EGR cooler 100 taken along line II-II of FIG. 1.

A space is provided in a housing 220, tubes 200 are arranged at predetermined intervals from an inner upper portion of the housing 220 to an inner lower portion of the housing 220, and a zigzag-shaped fin 205 is disposed in each of the tubes 200.

An upper portion of the fin 205 is brazed to an inner upper surface of the tube 200, and a lower portion of the fin 205 is brazed to an inner lower surface of the tube 200, thus the fin 205 improves heat transfer efficiency between the recirculated exhaust gas and the coolant.

A supporter 230 is interposed between successive tubes 200. The supporter 230 forms a coolant passage 210 between the tubes 200. An exhaust gas passage 215 through which the recirculated exhaust gas passes is provided inside the tube 200. The recirculated exhaust gas is cooled by the coolant passing the fin 205 and the tube 200.

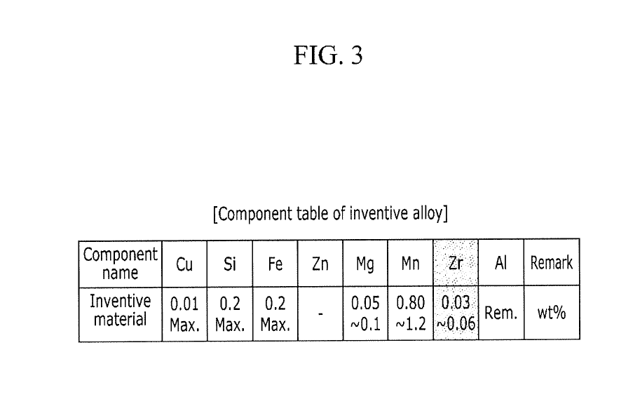

FIG. 3 illustrates a component table of an aluminum alloy used in a tube of an EGR cooler according to an embodiment of the present disclosure.

Referring to FIG. 3, the aluminum alloy used in the tube 200 of the EGR cooler 100 includes copper (Cu), silicon (Si), iron (Fe), magnesium (Mg), manganese (Mn), zirconium (Zr), and aluminum (Al).

The aluminum alloy includes less than or equal to 0.1 wt % of Cu, less than or equal to 0.2 wt % of Si, less than or equal to 0.2 wt % of Fe, between 0.05 and 0.1 wt % of Mg, at between 0.03 and 0.06 wt % of Zr, between 0.8 and 1.2 wt % of Mn, and aluminum as the remainder.

In the aluminum alloy according to an embodiment of the present disclosure, in order to improve corrosion resistance compared to that of a conventional A3003 material, 0.03 to 0.06 wt % of zirconium (Zr) is added.

Presence of Zr reduces grain size, thereby improving strength. It is possible to minutely disperse precipitates causing a potential difference in a material to suppress occurrence of pitting and to cause corrosion to uniformly occur. That is, when the corrosion is uniformly formed, penetration resistance due to the corrosion increases.

When more than a certain amount of Zr is included, the increased strength of the material makes extrusion difficult. Thus, zirconium is added in an amount of 0.06 wt % or less.

In addition, contents of Cu, Fe, and Si are reduced in order to promote a negative electrode reaction in a corrosive condition and to minimize occurrence of precipitates at grain boundaries in a texture., Although Mg is an element which generally improves the material strength of the alloy, since it causes adverse effects in brazing, a content thereof is optimized to 0.05 to 0.1 wt %.

Further, manganese, which is a main element of a 3***-based aluminum alloy, serves to improve strength without deteriorating corrosion resistance, and since Mn serves to improve the strength of the alloy, it is possible to maintain efficiency of extrusion by reducing a content thereof by a predetermined amount compared to that of the conventional A3003.

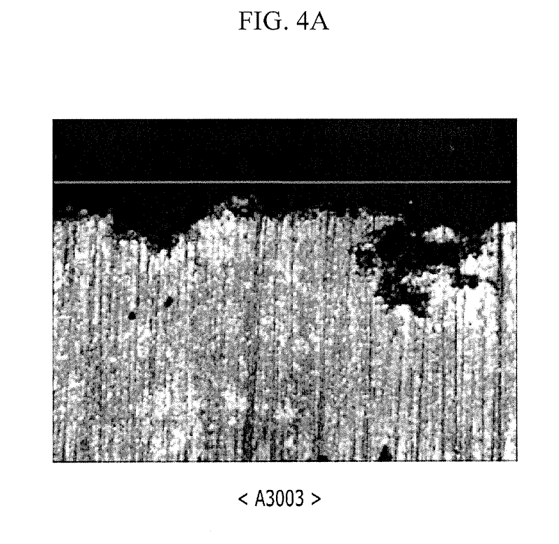

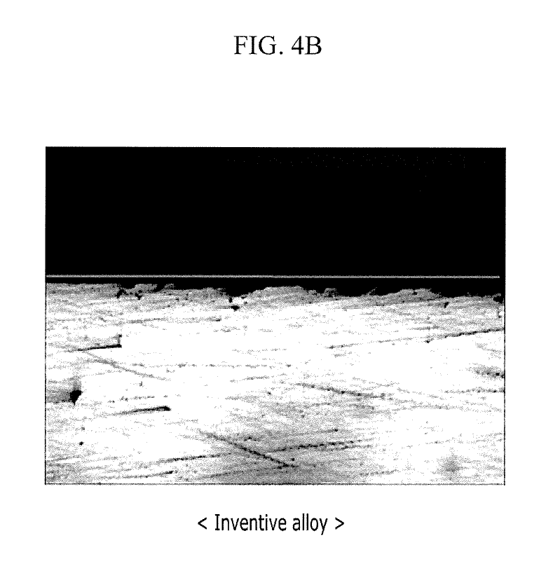

FIG. 4A and FIG. 4B illustrate cross-sectional views of an experiment result for an aluminum alloy according to an embodiment of the present disclosure.

Referring to FIG. 4A and FIG. 4B, the corrosion depth of the inventive alloy is relatively greater than that of the A3003 material.

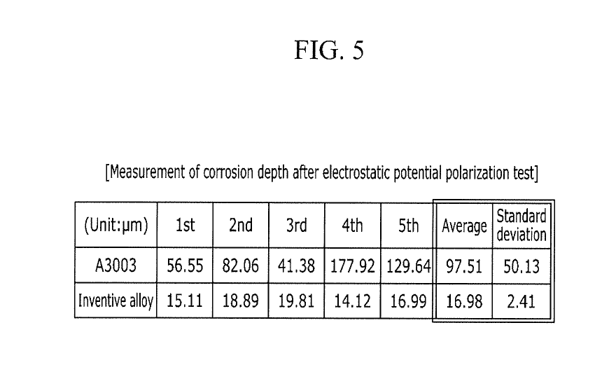

FIG. 5 illustrates a table representing a corrosion depth in an experimental aluminum alloy formed according to an embodiment of the present disclosure.

FIG. 5, which shows results of an electrostatic potential polarization test, shows the corrosion depths of the conventional A3003 alloy and the inventive alloy.

The electrostatic potential polarization test is a method of evaluating susceptibility to corrosion within a short period of time. In the electrostatic potential polarization test, specimens were polarized to be '1500 to −550 mV with a standard calomel electrode in a 3 wt % sodium chloride solution at room temperature, and then the state of corrosion was evaluated while maintaining for 144 hours.

As shown in FIG. 5, an average corrosion depth of A3003 is 97.51 μm and an average corrosion depth of the inventive alloy is 16.98 μm. Therefore, the corrosion resistance of the inventive alloy is greatly improved. Thus it is possible to prevent the coolant flowing in the EGR cooler 100 from flowing into the intake side of the engine.

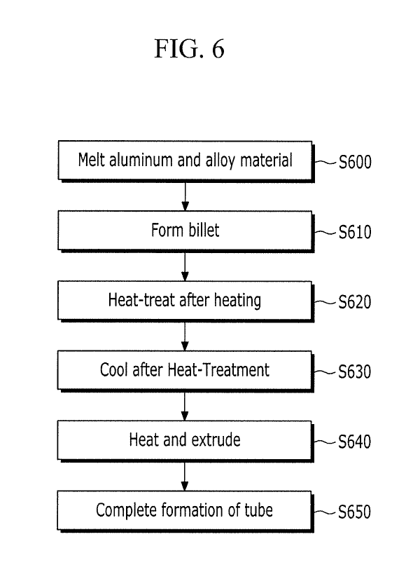

FIG. 6 illustrates a flowchart of a manufacturing method of an aluminum alloy according to an embodiment of the present disclosure.

Referring to FIG. 6, at S600 aluminum and an alloy material are melted in an electric furnace or induction furnace. Herein, the alloy material, as described above, includes copper, silicon, iron, magnesium, manganese, and zirconium.

At S610, a billet of a predetermined diameter (e.g., 6 inches) is manufactured by a billet caster. At S620 the manufactured billet is heat-treated at 550 degrees Celsius, maintained for 24 hours, and then at S630 air-cooled at room temperature; and at S640 the heat-treated billet is heated at 520 degrees Celsius and extruded into a tube shape using an extruder.

Then, at S650 the extruded product is cut to a predetermined length and washed to complete the formation of the tube 200. Next, the tube is assembled to a fin, a supporter (plate), and a housing (tank) through an additional process, and they are flux-processed and then brazed thereto in the brazing furnace.

The aforementioned embodiments are achieved by the disclosed subject matter in a predetermined manner. Each of the structural combination of structural elements and features of the elements or features can be considered selectively unless specified separately. Each of the structural elements or features may be carried out without being combined with other structural elements or features. Also, some structural elements and/or features may be combined with one another to constitute the embodiments of the disclosure. The order of operations described in the embodiments of the disclosure may be changed. Some structural elements or features of one embodiment may be included in another embodiment, or may be replaced with corresponding structural elements or features of another embodiment. Moreover, it will be apparent that some claims referring to a specific claim may be combined with another claim referring to the other claims other than the specific claim to constitute the embodiment or add new claims by means of amendment after the application is filed.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A tube comprising
an aluminum alloy comprising a predetermined weight ratio (wt %) of zirconium,
wherein the tube is made of the aluminum alloy.

2. The tube of claim 1, wherein
the aluminum alloy contains a predetermined weight ratio (wt %) of each of copper, silicon, iron, magnesium, and manganese.

3. The tube of claim 2, wherein
copper is present at up to 0.01 wt %, silicon is present at up to 0.2 wt %, iron is present at up to 0.2 wt %, magnesium is present at 0.05 to 0.1 wt %, manganese is present at 0.8 to 1.2 wt %, and zirconium is present at 0.03 to 0.06 wt %.

4. An exhaust gas recirculation (EGR) cooler having a tube, comprising
a tube comprising an aluminum alloy installed to cool exhaust gas recirculated from an exhaust line of an internal combustion engine to an intake line of the EGR cooler,
wherein the aluminum alloy comprises a predetermined weight ratio (wt %) of each of zirconium, silicon, iron, magnesium, and manganese.

5. The EGR cooler having the tube of claim 4, further comprising
a fin configured to be disposed in an exhaust gas passage inside the tube.

6. The EGR cooler having the tube of claim 5, wherein
the fin comprises an aluminum alloy, has a shape of a zigzag-bent plate, and is brazed to an inner surface of the tube.

7. The EGR cooler having the tube of claim 4, further comprising
more than one tube, each comprising the aluminum alloy; and
a supporter configured to be interposed between the more than one tubes to form a coolant passage.

8. The EGR cooler having the tube of claim 7, wherein
the supporter comprises an aluminum alloy, has a shape of a zigzag-bent plate, and is bonded to an outer surface of the tube.

9. The EGR cooler having the tube of claim 4, further comprising:
more than one tubes, each comprising the aluminum alloy; and
a housing in which the more than one tubes are disposed at predetermined intervals; and
an inlet and outlet pipe configured to serve for a coolant to flow in and be discharged from the housing, respectively.

10. A manufacturing method of a tube, co p sing:
melting aluminum and an alloy material to form a molten metal;
forming a billet of a first shape with the molten metal;
heat-treating the billet at a first temperature, maintaining the first temperature for a first time period, and then cooling the billet; and
heat-treating the heat-treated billet at a second temperature, and then extruding it into a second shape.

11. The manufacturing method of the tube of claim 10, wherein
the alloy material comprises copper, silicon, iron, magnesium, manganese, and zirconium.

12. The manufacturing method of the tube of claim 11, wherein
the molten metal comprises copper at up to 0.01 wt %, silicon at up to 0.2 wt %, iron at up to 0.2 wt %, magnesium between 0.05 and 0.1 wt %, manganese between 0.8 and 1.2 wt %, zirconium between 0.03 and 0.06 wt %, and aluminum being the remainder.

13. The manufacturing method of the tube of claim 11, wherein
the first temperature is 550 degrees Celsius.

14. The manufacturing method of the tube of claim 11, wherein
the first time period is 24 hours.

15. The manufacturing method of the tube of claim 11, wherein
in the cooling the billet comprises air-cooling the billet.

16. The manufacturing method of the tube of claim 11, wherein
the second temperature is 520 degrees Celsius.

17. An EGR cooler having a tube, the tube being manufactured by the method of claim 10.
